(19) United States
(12) Patent Application Publication
(10) Pub. No.: US 2005/0172262 A1
(43) Pub. Date: Aug. 4, 2005

(54) Site menu - browser toolbar-based user interface for navigating web site pages

(75) Inventor: Rajesh Lalwani, Saratoga, CA (US)

Correspondence Address: William L. Botjer, PO Box 478, Center Moriches, NY, 11934, US

(73) Assignee: AHIKA CORPORATION, SARATOGA, CA (US)

(21) Appl. No.: 10/769,003

(22) Filed: Jan. 30, 2004

(51) Int. Cl. G06F 9/44

(52) U.S. Cl. 717/109; 717/173

(57) ABSTRACT

The present invention generates a browser toolbar-based site navigation menu interface that appears uniform across different websites. A website developer can define and store the site menu contents in the web pages, root directory of the website, or a central repository. A central repository editor may also define and store the site menu contents for websites in the central repository. Some standard menu contents can also be defined for display along with the site menu. On downloading a web page, a search for corresponding site menu contents is performed on the web page HTML document, the root directory of the website and the central repository. The Site Menu contents are displayed along with the standard menu contents, using an interface program inside the browser toolbar. The present invention intends to make navigating across different websites as easy as the Windows and Apple menus for common tasks across different applications.

### BACKGROUND

The present invention relates to Graphical User Interfaces. More particularly, the present invention relates to generating a uniform interface for the efficient navigation of web site pages across different websites.

The Internet is a worldwide system of computer networks in which a user at a computer is able to exchange and/or view information from any other computer. All the resources and users on the Internet combine to form the World Wide Web (www or ‘the Web’). By means of the Web, it is possible to access and browse through millions of pages of information. Some of the most common web browsers are the Microsoft Internet Explorer and the Netscape Navigator. All of the information available on the Web is accessed via different websites. A website is an associated compilation of WWW files that contains a beginning file, normally called a home page. From the home page, it is possible to go to all the other pages of a website. Each file that is intended for display on a WWW browser page is prepared from a set of markup symbols or codes that are inserted in the file. The markup symbols and codes are responsible for telling the browser how to display words and images in a web page. Every individual markup code is referred to as a tag. One of the most commonly used markup languages is HTML (HyperText Markup Language). Other markup languages like DHTML (Dynamic HTML) and XML are being increasingly used.

One of the important features of the Web is hypertext. Hypertext is the organization of information units into connected associations that a user can choose to make. An instance of such an association is called a link or hypertext link. A hypertext link provides a platform for instant cross-referencing through hypertext links. Most of the websites contain words and phrases that come into view in a text of different color from the rest of the words and phrases. In addition to words and phrases, hypertext links can be presented to a user in the form of buttons or images. A user can access the web page that is relevant to one of these words, phrases, buttons or images by selecting and/or ‘clicking’ one of them. Normally, a menu is provided for enabling the user to navigate a specific website. The menu provided in a page includes a set of hypertext links that direct users to most of the site's web pages. For example, the home page of Business Week (www.businessweek.com) offers a menu-bar that is horizontally placed at the top of the page. Here, the menu puts forward an interface for the user to navigate to any desirable topic available on the website. In other words, the menu presents to a user, an overview of the contents of a particular website or a web page, and enables the user to navigate the website.

The menu is created through the HTML document related to a web page. As mentioned earlier, HTML is a language that is used to specify the construction of web pages. In other words, HTML is a standard that can allow website developers to mark areas of document that will become, for example, a title, a new paragraph, or italic text. Therefore, the elements of HTML consist of markup codes in the web page that instruct the web browser how the web page should be formatted when viewed. The menu is introduced in the web page by using various HTML elements such as <div>, <img> and <a href=>. In addition to defining the content of a menu, the web designer also needs to specify the appearance, format and location of the menu in a web page as well as a program to display, for example, a sub-menu. The most common locations for web menus are either horizontally on the top of the web page or vertically on the left side of the web page. The appearance, format and location of the menu differ with every website, and some times even with every web page contained in a website. However, the content of these menus is always customized to the contents of its website.

In addition, a JavaScript code is generally embedded in HTML pages. This code allows the website user to have the benefit of features such as: an automatic update of data fields on a web page, a pop-up window containing a hyperlinked page, a change in text or graphic image during a mouse rollover. In light of these benefits, menus are chiefly created using JavaScript and HTML, or a variation thereof. One of the variants of HTML is Dynamic HTML or DHTML, which is commonly used for programming a web menu. DHTML is a combination of new HTML tags and options that allow the developer to create web pages that are more animated and responsive to user interaction.

Hence, for the purpose of displaying menus in a web page, the website developer needs to define the contents of the menu as well as enable or activate the contents. These contents are enabled or activated by means of suitable programming that can convert contents to hyperlinks. Therefore, website menus are a form of graphical user interface that makes easier navigation of the site.

The website developer can either program the website menu interface using JavaScript or DHTML, or get help from one of the companies who specialize in DHTML and JavaScript-based website navigation menu software. Some companies that offer these kinds of software services are www.opencube.com, www.codethat.com, and www.milonic.com.

Graphical User Interfaces have generated active interest among a large section of computer users. Constant endeavors are made to enrich the graphical interface experience for a user. Some of these efforts are directed towards providing users with the ability to manipulate the properties of site menus, so as to achieve a desirable appearance or format for the menu. On the other hand, some of the efforts are aimed at providing software that automatically presents a menu in a user-specified style and format, after extracting possible menu contents from a particular site.

For example, U.S. Pat. No. 6,031,534, dated 29 Feb., 2000, assigned to Microsoft Corporation, and titled “Operating System Function For Specifying A Checked Image Representation And An Unchecked Image Representation Of A Menu Item”, provides a user interface wherein the user can bring about desirable changes in the appearance of a menu in an application program. The patent enables the user to achieve this feature by facilitating readily changing bitmaps for a menu item so as to accommodate changes in the appearance of a menu.

U.S. Pat. No. 5,742,768, dated 21 Apr., 1998, assigned to Silicon Graphics Inc., and titled “System And Method For Providing And Displaying A Web Page Having An Embedded Menu”, describes an applet that can be associated with a website with the intention that an embedded menu can be created and managed to navigate that website. Herein, the applet is transmitted along with the web page that is requested by the user, and downloaded by the web browser. According to this patent, the website developer designs the applet for the embedded menu, and the appearance of the menu or toolbar differs with each website.

U.S. Pat. No. 6,359,633, dated 19 Mar., 2002, assigned to Yahoo! Inc., and Titled “Apparatus And Method For Abstracting Markup Language Documents”, relates to a method for extracting a summary of a markup language document. The summary provides a set of hyperlinks for the user to navigate through the HTML document. Although this patent offers the user with an approach to gain an overview and facilitate ease of navigation, the overview or summary is limited to the web page or HTML document that is being accessed.

U.S. Pat. No. 6,035,330, dated 7 Mar., 2000, assigned to British Telecommunications, and Titled “World Wide Web Navigational Mapping System And Method”, goes a step further. This patent relates to an Internet navigational mapping system. The system presents a graphical representation of the structure of a Website so that the user can navigate through the website efficiently, using that particular structure. Here, the navigational map that is created by the system is stored in a map database that can be loaded locally or downloaded by a network browser.

The above patents have been incorporated herein by reference. The above patents provide methods for facilitating user navigation using menu interfaces. However, none of the systems in the prior art provide the user with a uniform menu interface, which would aid the user in the efficient navigation of different web pages across different websites. Furthermore, for some of the patents mentioned above, the menu is displayed in a separate window and not on a toolbar inside the browser. Additionally, most of the prior art systems require website developers to program the menu for display on a Web page.

Hence there is need for a system and method that would provide the user with a uniform site menu interface across several websites, in order to facilitate ease of navigation. Also, there is a need for a system and method that enables a website developer to create menus without manual programming. The website developer should have the option of creating the same menu for all the web pages, or different menus for some or all of the web pages. There is also a need for a system and method, so that a central repository can be created and maintained which contains menus for various websites that have not created their own site menus.

### SUMMARY

The present invention is directed to a method, a system, and a computer program for displaying a uniform menu for the web pages of a website in a toolbar inside the browser, without requiring a website administrator to actually program the menu.

An object of the present invention is to provide a method, a system, and a computer program that enables the user to efficiently navigate different web pages on websites by providing the menus for websites in which the menus are uniform in appearance across different websites.

Another object of the present invention is to provide a method, a system, and a computer program to create and modify menus, which do not require programming, by only defining the contents of the menus.

Another object of the present invention is to provide a method, a system, and a computer program to create menus to navigate the web pages of websites that have not even defined the contents of the menus.

A system in accordance with the present invention comprises a Web Services Client, a Toolbar Software, a Web Services Server, a Central Repository, a Web-based UI Server and one or more Central Repository Editor's PCs (personal computers). The system initiates the method for presenting a uniform menu when a user requests the downloading of a web page. On receiving such a request, the browser downloads the web page. The Toolbar Software at the Web Services Client looks for the menu contents in the HTML document of the web page. Toolbar Software at Web Services Client checks the HTML document for a <Sitemenu> tag. The menu contents are extracted from the <Sitemenu> tag. In case, the <Sitemenu> tag is not encountered in the HTML document, Toolbar Software at Web Services Client looks for the menu contents in a menu content file, called the sitemenu.xml, at the root directory of the website of the web page. The sitemenu.xml file is an XML file that defines the contents of menus and sub-menus for a web page. It is also possible for the developer to define the sitemenu.xml file and save it in the Central Repository. In addition to website developers' defined menu content files, the Central Repository may also contain menu content files for other websites. An editor may define these additional files for the websites for which menu content files have not been defined by the respective developers. Therefore, in case both the <Sitemenu> tag and the sitemenu.xml file are not encountered in the web page or on the website, menu contents are obtained from the menu content files stored in the Central Repository by sending a request to the Web Services Server.

The menu contents obtained are then parsed to check the contents—buttons, images, menus, submenus, etc. The images referenced in the menu contents are then fetched from the web page. The Toolbar Software at the Web Services Client generates a menu based on the menu contents and any standard toolbar contents. According to an embodiment of the present invention, the menu generated is similar in appearance to the menu toolbar provided by Microsoft Windows. The menu is presented on a toolbar inside the browser. The user may then navigate the website using the presented menu. The Toolbar Software instructs the browser to execute the actions chosen by the user, such as, execute a specific JavaScript or go to a specific web page.

In the entire process, only the menu contents are required to be defined. This is done by using XML. Therefore, no programming is required to display the menus. Also, no programming is required while defining the menu contents. Moreover, the present invention generates menus that are all uniform in appearance across different websites. Hence, the inconvenience caused to users by different styles and positions of navigation menus on different websites is eliminated.

### BRIEF DESCRIPTION OF THE DRAWINGS

The preferred embodiments of the invention will hereinafter be described in conjunction with the appended drawings provided to illustrate and not to limit the invention, wherein like designations denote like elements, and in which:

FIG. 1 illustrates an Internetworking environment where a system in accordance with the present invention can be implemented;

FIG. 2 is a block diagram illustrating the elements of the system in accordance with the present invention;

FIG. 3 is a flow chart illustrating an exemplary flow of tasks and processes in accordance with a method of the present invention;

FIG. 4 is a flow chart illustrating an exemplary flow of tasks and processes executed by the Toolbar Software;

FIG. 5 illustrates a browser window displaying a sample site menu interface of the present invention for a web page of a website;

FIG. 6 illustrates a browser window displaying another sample site menu interface of the present invention for a different web page of a different website;

FIG. 7 illustrates a browser window displaying yet another sample site menu interface of the present invention for a web page of a different website; and

FIG. 8 illustrates an example sitemenu.xml file for a web page.

### DESCRIPTION OF PREFERRED EMBODIMENTS

The present invention provides a ‘Site Menu’, which is a uniform Graphical User Interface (GUI) for Internet applications. The Site Menu interface is in the form of a menu inside the toolbar of a browser, the display of the menu being uniform in appearance for all web pages across all websites. However, the contents of the menu keep changing depending on the web page or website that is browsed. The menu allows a user to efficiently navigate a website.

Menus provided on a web page are often positioned at various locations for different websites. Therefore, a user has to go through the inconvenience of finding the menu and getting used to the position, images, text, and format for each menu. The present invention overcomes these difficulties by presenting the user with a web page or website-specific menu that always appears on the toolbar. Moreover, the present invention offers the user menus that are uniform in appearance. Therefore, the user observes a familiar menu for all web pages across different websites.

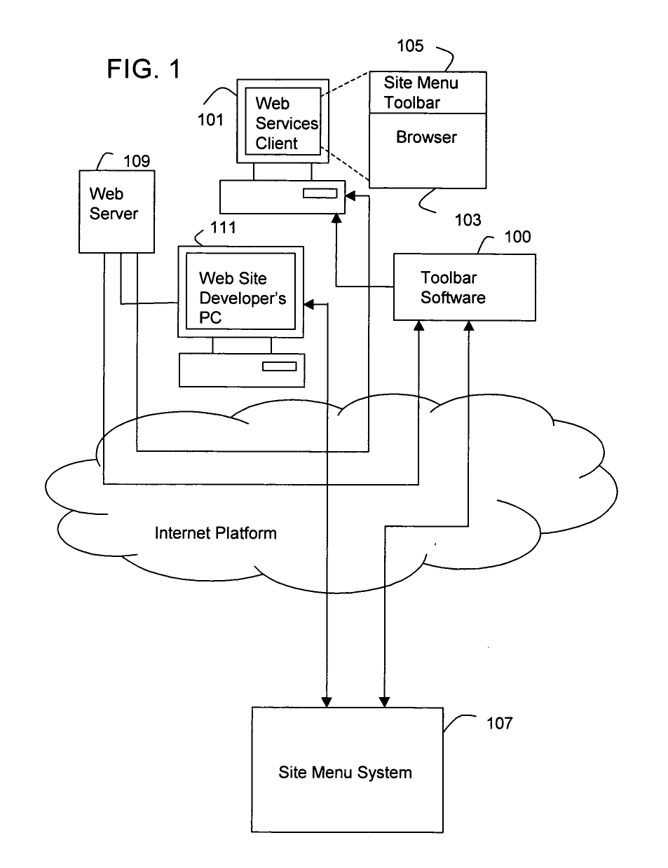

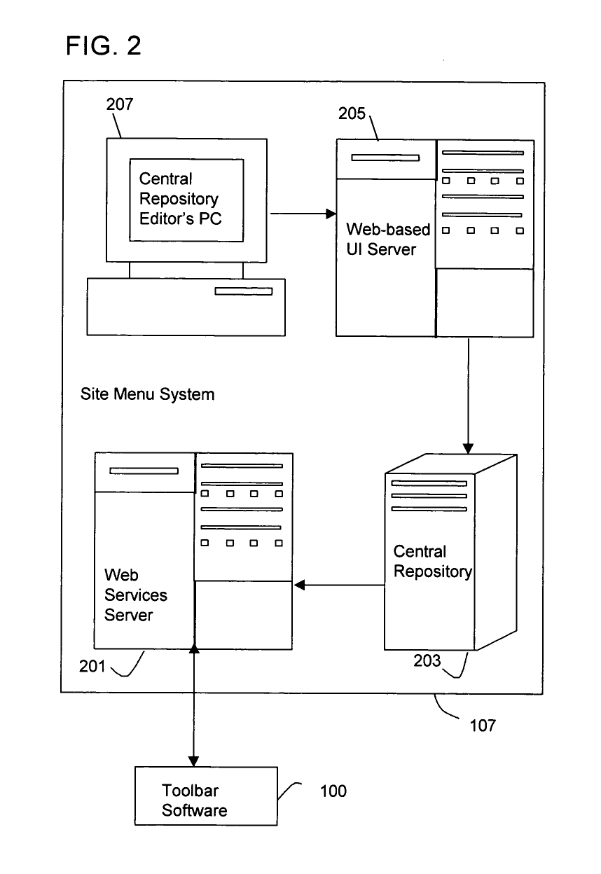

FIG. 1 illustrates an Internetworking environment where a system in accordance with the present invention can be implemented. The function provided by the system of present invention is embedded in a program called Toolbar Software 100. Toolbar Software 100 is a program that is installed and run by Web Services Client 101. Web Services Client 101 is a client, which uses Toolbar Software 100 of the present invention. The system, facilitating Toolbar Software 100 of the present invention, is hereby referred to as Site Menu System 107. All the system elements contained within Site Menu System 107 are explained with reference to FIG. 2. Herein, Site Menu System 107 is shown comprising a Web Services Server 201, a Central Repository 203, a Web-based UI Server 205, and a Central Repository Editor's PC 207.

The inventive application preferably operates independently using the Site Menu System software program called Toolbar Software, which is installed and run by Web Services Client 101.

Referring to FIG. 1, a Web Services Client 101 downloads a web page from a Web Server 109 over the Internet. The downloaded website or web page generally contains a navigating menu that is embedded into a Browser 103. In a preferred embodiment, Browser 103 is a Microsoft Windows Internet Explorer. However, the present invention should not be limited to Internet Explorer. Any other browser, including Mozilla or Netscape's Navigator, can be used. The navigating menu allows a user to navigate to various web pages within a website. Nevertheless, as mentioned earlier, this approach to navigate is at times confusing and time-consuming. Toolbar Software 100 of the present invention provides a user with a uniform Site Menu Toolbar 105 inside Browser 103. The menu displayed on Site Menu Toolbar 105, provided by Toolbar Software 100, is in addition to one or more menus that may have been provided within the displayed web page.

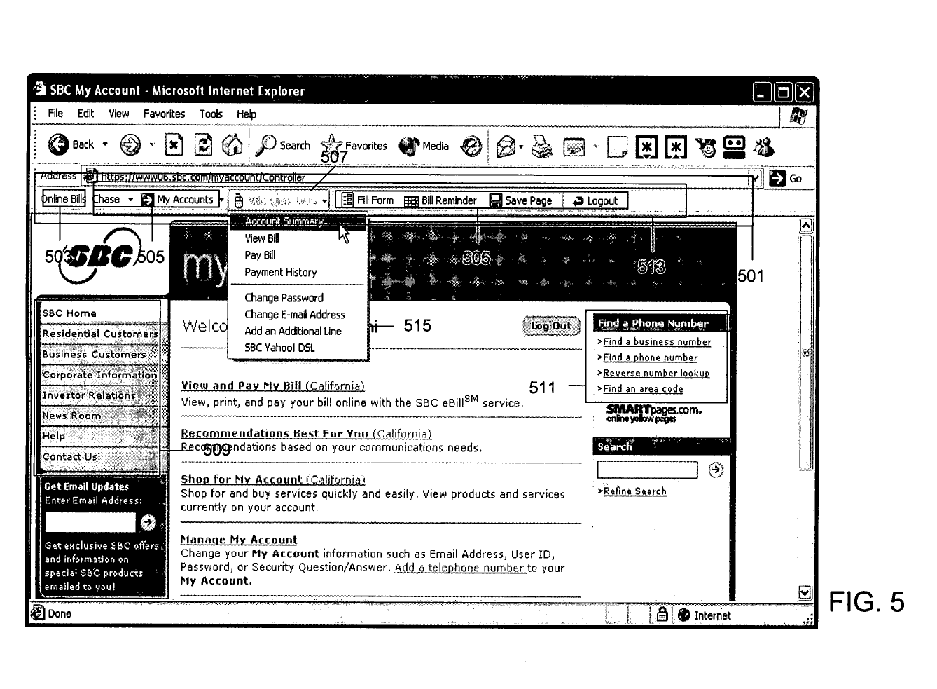

Toolbar Software 100 is an intelligent software process that is initiated each time a web page is downloaded by Browser 103. This software process resides in the Personal Computer (PC) of Web Services Client 101 after Web Services Client 101 installs and runs Toolbar Software 100. Toolbar Software 100 searches for the menu contents of the downloaded web page in the documents related to the web page. The menu contents may be present either in the markup language document of the web page, in the root directory of the website of that web page, or in a database that is maintained by Site Menu System 107. Subsequent to searching for the required information, Toolbar Software 100 extracts menu contents for the web page. Toolbar Software 100 is also responsible for displaying these menu contents inside Site Menu Toolbar 105 of Web Services Client 101. It is also possible for Toolbar Software 100 to contain some standard menus in addition to the web page or website specific menus, for the purpose of display to the user. The standard menus may provide links that Web Services Client 101 may desire to access at any time during browsing. The standard menus are displayed inside Site Menu Toolbar 105 for all web pages and websites that are downloaded by Web Services Client 101. Toolbar Software 100 merges site-specific menu contents with the standard menu contents to present Web Services Client 101 with a single Site Menu Toolbar 105. An example of site specific menu contents and standard menu contents has been illustrated in the screenshot of FIG. 5.

Site Menu Toolbar 105 is created using C++ as the programming language. However, the use of programming language should not be limited to C++. Other programming languages such as Visual Basic, C#, Java, or any other language, may be used. It is important to ensure that the programming language that is employed for the purpose of the present invention can use the Application Program Interface (API) that is supported by Browser 103. Once the menu contents are known, Toolbar Software 100 creates and presents the menu on Site Menu Toolbar 105.

Information regarding the menu contents of a web page can be extracted by Toolbar Software 100 from various sources. Information obtained from some of the sources is stored in a database contained by Site Menu System 107. This database is referred herein as Central Repository 203.

One of the possible sources from where information relating to the web pages of a website can be derived is Web server 109 of the website itself. In this case, first Toolbar Software 100 searches the HTML document of the Web page for a <Sitemenu> tag. However, the present invention should not be considered limited only to searching for the HTML documents. Other markup languages that are used for constructing Web pages, such as DHTML, XML, or any other language, may be used. The <Sitemenu> tag is an element in the markup language document of the web page which defines the contents of the menu within that web page.

Another source within the website may be the root directory of the website. It is possible for a web administrator or developer to store a file in the root directory for their website. Wherein, this file, an XML file, defines menu contents for a web page within the website.

In addition, Site Menu System 107 provides a user interface to the website administrator or developer to facilitate feeding of information about the menu contents of the web pages in that website to Central Repository 203.

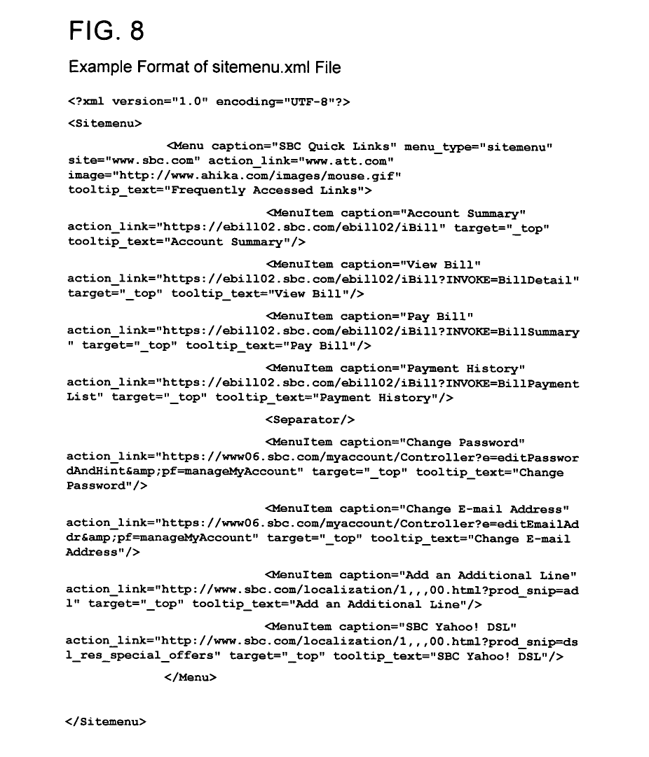

According to a preferred embodiment of the present invention, the website administrator or website developer can feed the information by uploading a sitemenu.xml file. An example of sitemenu.xml file has been illustrated in FIG. 8.

In order to make sure that the person claiming to be the website administrator or the developer of a particular website has the proper authority to define the contents of the Site Menu for that website, an editor to Central Repository 203 may ask for the person's credentials. According to a preferred embodiment, the editor to Central Repository 203 provides a unique Site Menu ID which must be stored in a file called sitemenu_id.xml in the root directory of the website. The ability of the person to store a sitemenu_id.xml file in the root directory of the website provides the necessary proof that the person has the authority to define the contents of the website.

Once the website administrator or developer uploads a sitemenu.xml file using the interface provided by Site Menu System 107, that file is stored in Central Repository 203. Here onwards, Site Menu System 107 is responsible for the generation and display of Site Menu Toolbar 105 corresponding to that particular website. Site Menu System 107 also defines the appearance and location of the menus on the Site Menu Toolbar 105 and its contents, that are specific to that website. Hence, a web administrator or developer is saved from the need to program the display of Site Menu Toolbar 105. This feature of Site Menu System 107 makes the system of the present invention easy to use for the website administrator or developer.

However, it should be noted that the website administrator or developer creates the sitemenu.xml file. The sitemenu.xml file can be created, using any editor, such as XML Spy or Notepad, to generate and edit XML files.

Another possible source for obtaining information relating to the menu contents of the web pages within a website can be within Site Menu System 107. Herein, one or more editors may be employed for generating menu contents for websites. An interface, similar to that provided for web administrators and developers, is provided to editors of Central Repository 203. This interface enables an editor to upload sitemenu.xml files forwebsites to a server that directs all such information to Central Repository 203. Hence, sitemenu.xml files that are uploaded by the editor are consequently stored in Central Repository 203. Site Menu System 107 also provides for a method wherein an editor, with proper access rights, creates the sitemenu.xml file for a web page within a website directly on the server. An editor is required to provide information for websites for which the <Sitemenu> tag or the sitemenu.xml file could not be found, in the markup language document, or in the root directory of the website.

By and large, Site Menu System 107 acts as an Application Service Provider (ASP). Toolbar Software 100 is supported by Site Menu System 107 that obtains, manages, and provides menu content information for Web Services Client 101. By means of the ASP-based architecture of the system of the present invention, users are able to efficiently navigate through different websites.

The functions provided by Site Menu System 107 are not limited to the display of Site Menu Toolbar 105 to users. As mentioned earlier, Site Menu System 107 also allows the website administrator or developer to conveniently create a menu for their website. Toolbar Software 100 is an intelligent program that can extract, interpret and display the menu contents of a web page within a website by merely searching for related data in that website or in Central Repository 203.

As has been mentioned earlier, Site Menu System 107 comprises multiple elements, with each element being specific to a particular functionality. Referring again to FIG. 2, the functioning of Site Menu System 107 and its elements is described below.

Site Menu System 107 consists of a Web Services Server 201 that supports Toolbar Software 100 for presentation of Site Menu Toolbar 105 in Browser 103. Also, Site Menu System 107 contains a Central Repository 203, which is a database that contains menu content information corresponding to the websites, and feeds this information to Web Services Server 201. Further, Site Menu System 107 contains a Web-based UI Server 205, which provides user interfaces to website administrators and Central Repository 203 editors, to facilitate their uploading information to Central Repository 203. Site Menu System 107 also contains one or more Central Repository Editor's PC 207, using which, Central Repository 203 editor creates and modifies menu content information. All of the above-mentioned elements are explained in detail hereafter.

Web Services Server 201

Web Services Server 201 is responsible for providing an interface between Toolbar Software 100 and Central Repository 203. In other words, Web Services Server 201 carries out the function of a gateway. Broadly speaking, a gateway is a network point that acts as an entrance into another network. Therefore, Web Services Server 201 acts as a gateway for communication of information from Central Repository 203 to Toolbar Software 100. For the purpose of the present invention, the information is in the form of a sitemenu.xml file that is stored in Central Repository 203. Web Services Server 201 performs this operation on Central Repository 203 each time Web Services Client 101 downloads a web page and Toolbar Software 100 is unable to extract either <Sitemenu> tag, or the sitemenu.xml file from the root directory of that website. Web Services Server 201 then searches for the corresponding sitemenu.xml file for that web page in Central Repository 203. It is possible to enhance the performance by caching the information in Web Services Client 101, so that Toolbar Software 100 communicates with Web Services Server 201 only once a day for the same web page, or only when information about a website is stored in Central Repository 203.

Programs residing in Web Services Server 201 provide Web Services Client 101 with the services of the present invention over the Internet. Web Services Server 201 has a client/server-programming model, wherein programs at Web Services Server 201 await and fulfill requests from client programs. In a preferred embodiment of the present invention, a client request is received each time a user at User PC 101 downloads a web page into Browser 103, and Toolbar Software 100 is unable to extract either the <Sitemenu> tag, or the sitemenu.xml file from the root directory of that website. In response to this request, Web Services Server 201 searches Central Repository 203 for that web page's corresponding sitemenu.xml file. Web Services Server 201 then communicates the information obtained from Central Repository 203 to Toolbar Software 100. As already mentioned, the sitemenu.xml file contains the <Sitemenu> tag. Wherein, the <Sitemenu> tag contains information regarding menu contents for the corresponding web page. Toolbar Software 100 utilizes this information contained in the <Sitemenu> tag to extract menu contents for displaying Site Menu Toolbar 105 inside Browser 103 for the Web page that is downloaded by the user. Optionally, the Web Services Server 201 may merge the standard toolbar contents with the web page-specific contents, and send the merged content containing a <Toolbar> tag to Toolbar Software 100.

Central Repository 203

Central Repository 203 is a form of memory where sitemenu.xml files corresponding to several websites are stored. In other words, Central Repository 203 is a database of XML files from which Web Services Server 201 identifies a sitemenu.xml file corresponding to a requested Web page, to send the file to Toolbar Software 100. The mapping is performed, and a corresponding sitemenu.xml file is sent only if Toolbar Software 100 fails to locate either the <Sitemenu> tag in the markup language document, or the sitemenu.xml file of the web page. FIG. 8 illustrates an example of a sitemenu.xml file for a web page.

The system of the present invention facilitates access to one or more persons to maintain Central Repository 203. These are called editors to Central Repository 203. Editors to Central Repository 203 can also upload sitemenu.xml files using Web-based UI Server 205.

The menu contents information is fed to Central Repository 203 from all different sources, using web-based UI Server 205.

Web-based UI Server 205

The chief purpose of Web-based UI Server 205 is to provide an interface for website administrators and developers, and editors to Central Repository 203, to upload information concerning the menu contents of the web pages within a website. The system of the present invention ensures proper authentication of the website administrator or developer to define the Site Menu contents for a website. The information concerning menu contents is in the form of a sitemenu.xml. In other words, Web-based UI Server 205 is a server that presents an interface for collecting information, and feeding and updating Central Repository 203 with that information.

The interface provided by Web-based UI Server 205 is of significance to website developers and administrators who want to upload a sitemenu.xml file to Central Repository 203. This feature enables display of Site Menu Toolbar 105 in Browser 103 of Web Services Client 101 each time a web page within a website belonging to the web administrator or developer is downloaded. It is also possible for a website developer or administrator to modify or update an already existing sitemenu.xml file for their website, using the same interface provided by Web-based UI Server 205. This feature, provided by Site Menu System 107, also allows modification of web page-related information without the need for programming or re-programming of previously fed information.

A similar interface is provided to an editor of Central Repository 203. Using this interface, an editor can upload sitemenu.xml files for several websites. The editor creates these sitemenu.xml files. The system of the present invention also facilitates the editor, with proper access rights, to create a sitemenu.xml file for a web page on Web-based UI Server 205. In the latter case, a sitemenu.xml file is directly created on Web-based UI Server 205 and fed to Central Repository 203.

Central Repository Editor's PC 207

Site Menu System 107 editor, through Central Repository Editor's PC 207, provides menu content information in the form of sitemenu.xml files. The editor provides information corresponding to the websites and web pages for which the system of the present invention has been unable to collect any menu content information due to the absence of either the <Sitemenu> tag in an HTML document related to a website, or by input from the website administrator or developer for their website. The latter may occur in websites whose developers have not yet chosen to define a sitemenu.xml file either in their websites' root directory or in Central Repository 203, using Web-based UI Server 205.

Process flow for the Site Menu

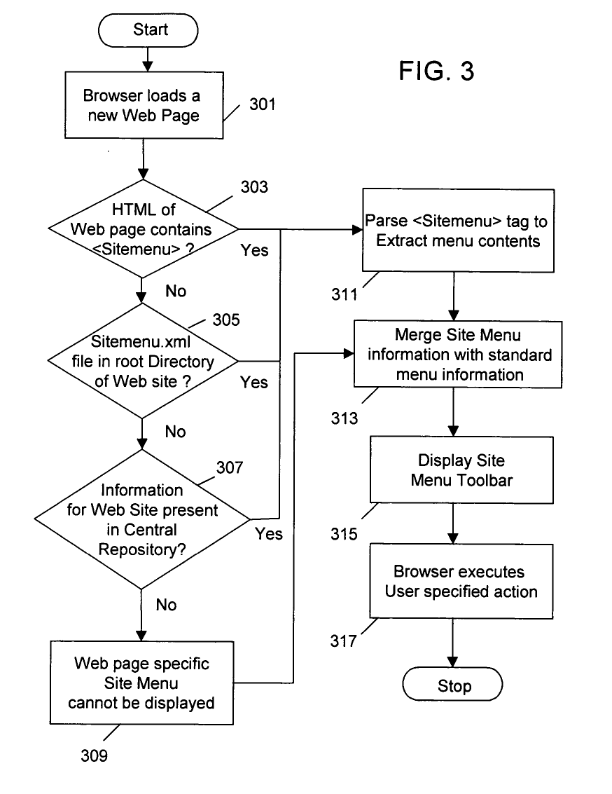

The flow chart of FIG. 3 illustrates an exemplary flow of tasks and processes in the system in accordance with the present invention. At step 301, Toolbar Software 100 is initiated each time Web Services Client 101 downloads a new web page into Browser 103. Following step 301, at step 303, Toolbar Software 100 searches the HTML document related to the web page for a <Sitemenu> tag. As mentioned earlier, the <Sitemenu> tag lists all the details that define the contents of the menu corresponding to a web page.

As soon as the <Sitemenu> tag is found, the system proceeds to step 311. However, in case no <Sitemenu> tag is found by Toolbar Software 100, then Toolbar Software 100 explores the root directory of the website for a sitemenu.xml file at step 305. The website administrator is responsible for creating the sitemenu.xml file and storing it at the root directory of its website. Once the file is found at this location, the system proceeds to step 311. However, if the search at this location is also ineffective, the system continues to step 307. At step 307, it looks for site menu information in the form of the sitemenu.xml file corresponding to the web page or website in Central Repository 203.

In case steps 303, 305 and 307 are unable to yield the desired information, the system of the present invention proceeds to step 309. If at step 309, the system concludes that there is no information for generating contents for Site Menu Toolbar 105 that are specific to that web page within the website the system proceeds to step 313. At step 313, information regarding Site Menu contents is merged with the information regarding standard menu contents that are always presented to the user. In this case, since the web page-specific site menu information is not present, the system displays only standard menu contents at step 315. Toolbar Software 100 gets these standard buttons from Web Services Server 201. The contents of standard buttons usually remain uniform across all websites and web pages that are downloaded by Web Services Client 209, but can vary for each Web Services Client 209.

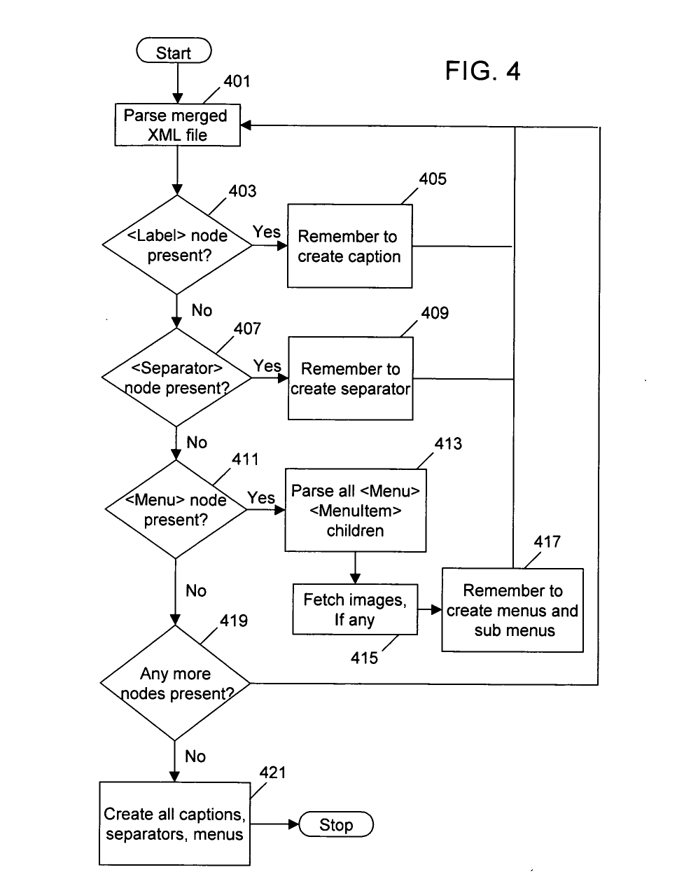

On the other hand, if any of the searches carried out in steps 303, 305 and 307 present Toolbar Software 100 with the required information, then the system proceeds to step 311. Herein, at step 311, Toolbar Software 100 parses either the <Sitemenu> tag in the HTML document, or the <Sitemenu> tag in the sitemenu.xml file, to extract the menu contents. The menu contents extracted may be in the form of buttons, images, menu structures, sub-menu structures, or in any other form. At step 313, the Toolbar Software merges the web page or website specific contents if available, with the standard contents to create the contents for the entire toolbar containing the <Toolbar> tag. At step 315, Toolbar Software 100 uses the merged toolbar contents to create a uniform looking menu. This step is further explained in FIG. 4.

In accordance with a preferred embodiment of the present invention, Site Menu Toolbar 105 is displayed in a format that is similar to the menu on Microsoft's Windows application. However, the present invention should not be considered limited to the format provided in Microsoft's Windows. Other formats that are widely in use or formats that are provided by other operating systems may be referenced. Additionally, it is possible to utilize images by including them inside Site Menu Toolbar 105 buttons or icons that are created by Toolbar Software 100 in accordance with an embodiment of the present invention. Images make Site Menu Toolbar 105 more attractive and user-friendly. At step 317, once Site Menu Toolbar 105 has been displayed, the user interacts with the menu to execute certain tasks. For instance, a user may click on a text or title presented, using buttons or icons inside Site Menu Toolbar 105, in order that the browser directs the user to a new web page or to execute a specific JavaScript. This action is performed preferably with the help of functions such as but not limited to a GetToolBar function. It is also possible that when a user clicks on a button inside Site Menu Toolbar 105, another menu is displayed. This is called a pop-up menu. According to a preferred embodiment of the present invention, functions such as, but not limited to, a ShowPopupMenu function are used to display the pop-up menu.

FIG. 4 elucidates step 315 of FIG. 3. In step 315, the Site Menu Toolbar is displayed. According to step 401, Toolbar Software 100 first parses the merged XML file. The file is parsed in recursive, depth-first order. In step 403, Toolbar Software 100 traverses nodes in the XML file. If a <label> node is encountered, Toolbar Software 100 proceeds to step 405. At step 405, Toolbar Software 100 stores a command to create a caption in Site Menu Toolbar 105. From step 405, the process flows back to step 401. Hence, Toolbar Software 100 remains in a loop until all nodes have been traversed. In case the current node is not a <label> node, the process continues to step 407. At step 407, Toolbar Software 100 searches for a <Separator> node. If the <Separator> node is present, Toolbar Software 100 proceeds to step 409. At step 409, Toolbar Software 100 stores a command to create a separator corresponding to the separator found in the search in Site Menu Toolbar 105. Toolbar Software 100 uses the following to create a separator:

TBBUTTON BtnData;

BtnData.fsStyle=BTNS_SEP

It is commonly known to a person skilled in the art that a data structure such as but not limited to TBBUTTON is used to carry the information about buttons in a menu. Additionally, fsStyle is used to define the button style. Herein, the button is a separator, and hence fsStyle is set to BTNS_SEP.

Furthermore, from step 409, the process flows back to step 401. The process remains in this loop until all the nodes have been traversed. In case the current node is not a <Separator> node, the process flows to step 411. At step 411, Toolbar Software 100 conducts a search for <Menu> nodes. In case a <Menu> node is found, Toolbar Software 100 proceeds to step 413, where it parses all <Menu> or <MenuItem> children in a recursive, depth-first order. In this step, Toolbar Software 100 uses the structure such as but not limited to the following:

TBBUTTON BtnData; BtnData.fsStyle|=BTNS_BUTTON;

BtnData.fsStyle|=BTNS_WHOLEDROPDOWN

In these structures, BTNS_BUTTON creates a standard button. Moreover, BTNS_WHOLEDROPDOWN specifies that the button will have a drop-down arrow. Proceeding further, at step 415, it fetches any images that may have been specified in the <Menu> or <Menultem> nodes. It may be appreciated by a person skilled in the art that functions such as but not limited to the URLDownloadToCacheFile function can be used to download image data into the Internet cache. Following this, Toolbar Software 100 stores a command to create menus and submenus corresponding to the information obtained. From here, the process flows back to step 401 and remains in this loop until all nodes have been traversed. In case more nodes are present, Toolbar Software 100 proceeds to step 401 and remains in this loop until the search for all the nodes has been completed. Subsequent to concluding the search, at step 421, Toolbar Software 100 creates all the captions, separators, menus, etc., in the order. Step 421 is executed with the help of SendMessage TB_INSERTBUTTON to create all the captions, separators, buttons and drop-down menus on the toolbar. From step 421, Toolbar Software 100 proceeds to step 315 of FIG. 3.

FIG. 5 illustrates a sample site menu interface of the present invention that is displayed in Site Menu Toolbar 105 of Browser 103. Browser 103, used herein, is Microsoft's Internet Explorer. Nevertheless, the present invention allows the use of any other browser such as Mozilla or Netscape's Navigator. The menu that is displayed in FIG. 5 relates to SBC's website. This menu, called Site Menu 501, corresponds to Site Menu Toolbar 105 of Web Services Client 101. Site Menu 501 can be seen on top of the website, below the address toolbar, inside the browser window. Site Menu 501 of the present invention may optionally display a short title, called Toolbar Title 503, of the toolbar. The remaining part of Site Menu 501 is further divided into two parts: 505, 507. The first part 505 consists of six standard buttons: ‘Chase’, ‘My Accounts’, Fill Form’, ‘Bill Reminder’, ‘Save Page’, and ‘Logout’. The other part, 507, consists of buttons that display menus and sub-menus that are specific to the web page. These contents are hereby referred to as Site Menu Interface 513. Site-specific Site Menu tab 507 can display any possible contents for the web page in FIG. 5. It is evident that the web page for SBC already has a menu 509 placed vertically on the left side in the browser window. An additional menu, 511, is seen in the right-hand side of the web page. Additional menu 511, similar to menu 509, is also provided by the web page itself. Contents of menus 509 and 511 are useful for directing a user to other parts of the website, which may not directly relate to the functions that are offered by the web page in FIG. 5. However, the contents of Site Menu 501 of the present invention offer the user a broad overview of the functions provided by the web page, as well as of the website. Services presented by separate menus inside a web page are combined into a comprehensive menu, provided in Site Menu 501. The standard buttons 505, incorporated by Site Menu 501, encapsulate various services commonly provided across different websites.

Every time Web Services Client 101 selects one of the contents from Site Menu Interface 513, the action associated with that content is executed. For example, sub-menus for that content may appear in a drop-down box 515, and the user may be directed to another web page, and so forth. The display of sub-menu 515 depends on the hierarchical classification of the corresponding web page and website.

Site Menu 501 facilitates ease of navigation for the user since it provides an interface that is familiar to the user. The screenshot of a web page in FIG. 5 illustrates that Site Menu Interface 513 is similar in appearance to the menu toolbar provided by Windows that is located at the topmost part of the window. Images added to the contents make Site Menu Interface 513 eye-catching and user-friendly.

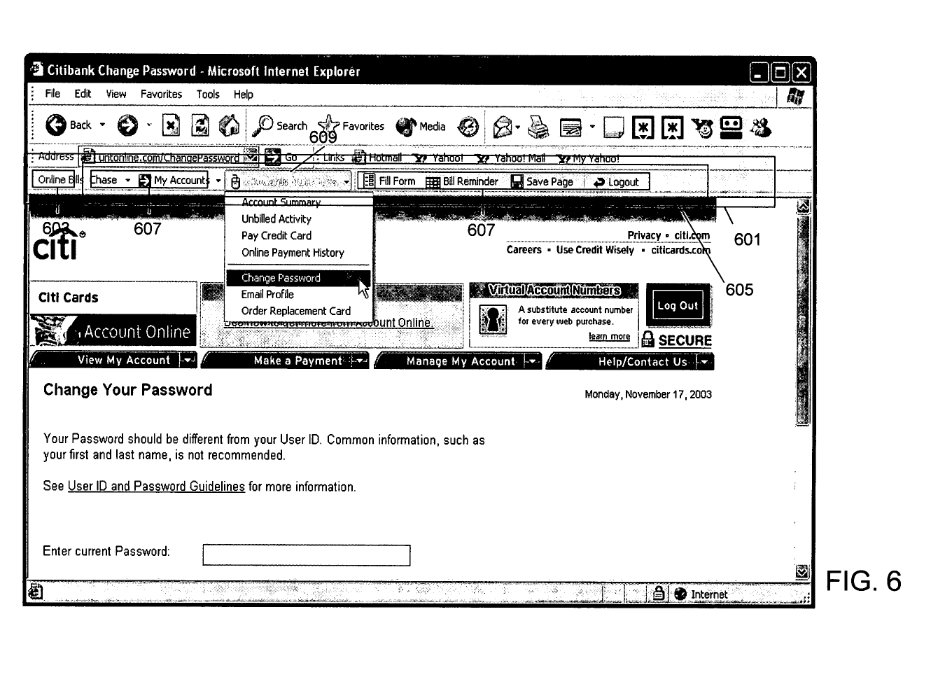

FIG. 6 illustrates another website, which is for Citibank. The menu presented by Site Menu System 107 is Site Menu 601. By observing FIG. 5 and 6, it follows that Site Menu 501 and Site Menu 601 are uniform in appearance. Here too, Site Menu 601 consists of a Toolbar Title 603. Toolbar Title 603 remains the same as in FIG. 5. This is because the web pages displayed in FIG. 5 and 6 have similar functions. Additionally, Site Menu 601 consists of a Site Menu Interface 605, which may be further divided into two parts. The first part, 607, consists of standard buttons that are identical to the standard buttons of FIG. 5. The second part, 609, consists of a menu and sub-menu that are specific to the contents of the web page of FIG. 6. Therefore, the Site Menu appearance is uniform throughout all the web pages that are browsed by the user.

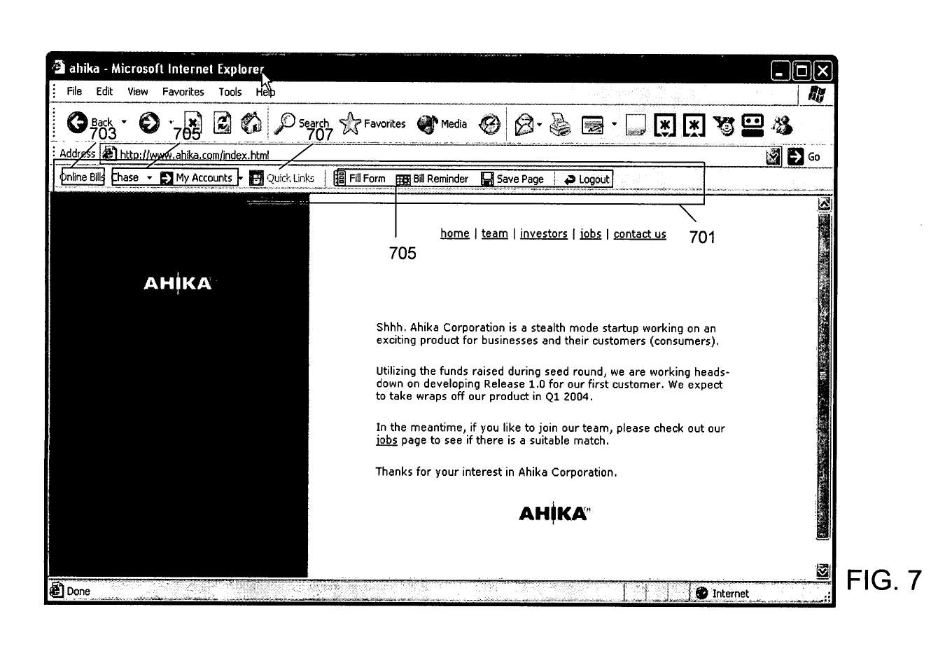

FIG. 7 shows yet another web page of a different website, for which a Site Menu 701 has been created by Toolbar Software 100. Referring to FIG. 7, the rightmost part (Toolbar Title 703) of Site Menu 701 shows the title of the toolbar. The remaining part of Site Menu 701 again consists of two parts. The first part, 705, comprises standard buttons that have not changed in either content or appearance. The second part, 707, comprises an inactive menu button. The button is inactive because no information about the menu contents available for the web page. Referring to FIG. 3, this implies that Toolbar Software 100, according to step 309, concludes that Site Menu Toolbar 105, specific to the web page, cannot be displayed. Consequently, it is apparent that Site Menu Toolbar 105 of the present invention remains uniform in appearance for all web pages across websites. At the same time, the contents of Site Menu Toolbar 105 are customized in accordance with each web page and website. Also, standard contents provided by Toolbar Software 100 remain in Site Menu Toolbar 105 for each web page and website.

A person skilled in the art will appreciate that the process of the present invention can be programmed using C++ as a programming language. However, other programming languages such as Visual Basic, C#, Java, or any other language, can also be used instead of C.

Additionally, a person skilled in the art can appreciate that all the connections between the various elements of the system of the present invention may be wired or wireless, depending upon the requirements of the system. Also, it should be noted that it is not essential that the various processing machines and/or storage elements be physically located in the same geographical location. The processing machines and/or storage elements may be located in geographically distinct locations and connected to each other to enable communication. This facilitates convenient and speedy navigation of websites.

While the preferred embodiments of the disclosed method have been illustrated and described, it will be clear that the disclosed method is not limited only to these embodiments. Numerous modifications, changes, variations, substitutions and equivalents will be apparent to those skilled in the art, without departing from the spirit and scope of the disclosed method.

1. A method for creating a uniform menu interface for navigating web pages across a website, without the need for manual programming of the menu interface, the method comprising the steps of:
a. Prodding, to a memory, the contents for the menus for a plurality of websites;
b. downloading a web page of a website into a browser;
c. searching the menu contents of the downloaded web page,
d. extracting the menu contents of the web page; and
e. displaying the menu contents on a toolbar inside the browser as a menu, the menu contents executing an action on selection.

2. The method according to claim 1, wherein the menu interface is similar in appearance to a standard menu on Windows applications.

3. The method according to claim 1 wherein the step of providing the contents for the menu comprises storing the contents in the memory in XML format.

4. The method according to claim 1 wherein the step of providing the contents for the menu comprises the step of uploading contents in XML format by a website administrator/developer.

5. The method according to claim 4 wherein the website administrator/developer is required to provide an identity.

6. The method according to claim 1 wherein the step of providing the contents for the menu is performed by an editor with access rights to the memory.

7. The method according to claim 1 wherein the step of extracting the menu contents of the website that correspond to the downloaded web page is performed by extracting the menu contents from the markup language document of the web page.

8. The method according to claim 1 wherein the step of extracting the menu contents of the website that correspond to the downloaded web page is performed by extracting the menu contents from the root directory of the website.

9. The method according to claim 1 wherein the step of extracting the menu contents of the website that correspond to the downloaded web page is performed by extracting the menu contents from the memory.

10. The method according to claim 1 wherein the extracted menu contents include at least one of: buttons, images, menu structures, and sub-menu structures.

11. A method for creating a uniform site menu interface for navigating web pages across a website, without the need for manual programming of the site menu interface, the method comprising the steps of:
a. downloading a web page of a website into a browser;
b. searching the menu contents of the downloaded web page, the searching being performed on the markup language document of the web page for the sitemenu tags;
c. extracting the menu contents of the web page from the sitemenu tag; and
d. displaying the menu contents on a toolbar inside the browser as a menu, the menu contents providing links to web pages of the website.

12. The method according to claim 11, wherein the menu interface is similar in appearance to a standard menu on Windows applications.

13. The method according to claim 11 wherein the extracted menu contents include at least one of: buttons, images, menu structures, and sub-menu structures.

14. A method for creating a uniform site menu interface for navigating web pages across a web, the method comprising the steps of:
a. downloading a web page of a website into a browser;
b. searching the menu contents of the downloaded web page, the searching being performed on the root directory of the website;
c. extracting the menu contents of the web page; and
d. displaying the menu contents on a toolbar inside the browser as a menu, the menu contents providing links to web pages of the website.

15. The method according to claim 14, wherein the step of searching being performed on the root directory of the web page is for menu content in XML format.

16. The method according to claim 14, wherein the menu interface is similar in appearance to a standard menu on Windows applications.

17. The method according to claim 14 wherein the extracted menu contents being at least one of: buttons, images, menu structures, and sub-menu structures.

18. A method for creating a uniform site menu interface for navigating web pages across a website, the method comprising the steps of:
a. providing, to a memory, the contents for the menu for the websites;
b. downloading a web page of a website into a browser;
c. requesting a search for menu contents of the downloaded web page;
d. searching the menu contents of the downloaded web page, the searching being performed on the memory;
e. extracting the menu contents of the web page; and
f. displaying the menu contents on a toolbar inside the browser, the menu contents providing links to web pages of the website.

19. The method according to claim 18, wherein the menu interface is similar in appearance to a standard menu on Windows applications.

20. The method according to claim 18 wherein the step of providing the content for the menu comprises storing the content in the memory in XML format.

21. The method according to claim 18 wherein the step of providing the contents for the menu is performed by a website administrator/developer by uploading menu contents in XML format.

22. The method according to claim 21 wherein the website administrator/developer is required to provide an identity.

23. The method according to claim 18 wherein the step of providing the contents for the menu is performed by an editor with access rights to the memory.

24. The method according to claim 18 wherein the extracted menu contents being at least one of: buttons, images, menu structures, and sub-menu structures.

25. A system providing a uniform menu interface for display inside a browser, customized for a website or web page, the menu interface being uniform in appearance across all websites, the system comprising:
a. a computer system running a process for searching, extracting and displaying menu contents for a web page, wherein searching of the menu contents is first performed on the markup language document of the web page, second on the root directory of the website, and then a request is sent to a first server;
b. a first server having an interface for communicating over a computer network, said first server supporting the display of the menu interface inside the browser;
c. a memory for storing data for access by the first server, the data including information relating to content of said menu for the website or web page; and
d. a second server having an interface for communicating over a computer network, said second server providing a user interface for creating and/or updating data in the memory.

26. A computer program product for use with a computer, for creating a uniform menu interface for navigating web pages across a website, said computer program product performing the steps of:
a. providing, in a memory, contents for the menu for the websites;
b. downloading a web page of a website into a browser;
c. searching the menu contents of the downloaded web page,
d. extracting the menu contents of the web page; and
e. displaying the menu contents on a toolbar inside the browser, the menu contents executing an action on selection, wherein the displaying of the menu contents is independent from manual programming.
